(19) United States
(12) Patent Application Publication
(10) Pub. No.: US 2026/0268093 A1
(43) Pub. Date: Sep. 10, 2026

(54) INFORMATION PROCESSING SYSTEM, INFORMATION PROCESSING METHOD, AND NON-TRANSITORY RECORDING MEDIUM

(71) Applicants: Yuta Nozaki, KANAGAWA (JP); Naoki Asaba, KANAGAWA (JP)

(72) Inventors: Yuta Nozaki, KANAGAWA (JP); Naoki Asaba, KANAGAWA (JP)

(73) Assignee: Ricoh Company, Ltd., Tokyo (JP)

(21) Appl. No.: 19/557,725

(22) Filed: Mar. 5, 2026

(30) Foreign Application Priority Data
Mar. 7, 2025 (JP) 2025-036842
Sep. 30, 2025 (JP) 2025-163395

(51) Int. Cl. G06F 40/40; G06F 40/284

(52) U.S. Cl. CPC G06F 40/40; G06F 40/284

(57) ABSTRACT

An information processing system includes circuitry that generates a third vector using similarities between a first vector and respective second vectors, the first vector representing a new character string added to a language model, the second vectors each representing a respective one of a plurality of words to which the new character string is divided, the third vector corresponding to the new character string, and registers the third vector in a vector table included in the language model.

### CROSS-REFERENCE TO RELATED APPLICATIONS

This patent application is based on and claims priority pursuant to 35 U.S.C. §119(a) to Japanese Patent Application Nos. 2025-036842, filed on Mar. 7, 2025, and 2025-163395, filed on Sep. 30, 2025, in the Japan Patent Office, the entire disclosure of which is hereby incorporated by reference herein.

### BACKGROUND

### Technical Field

The present disclosure relates to an information processing system, an information processing method, and a non-transitory recording medium.

### Related Art

Embedding vectors allow conversion of identifiers (IDs) assigned by a tokenizer to respective divided words into vectors. In relation to large language models (LLMs), there is a technique for performing contrastive learning when generating such embedding vectors to generate word embedding vectors.

### SUMMARY

The present disclosure described herein provides an information processing system including circuitry that generate a third vector using similarities between a first vector and respective second vectors, the first vector representing a new character string added to a language model, the second vectors each representing a respective one of a plurality of words to which the new character string is divided, the third vector corresponding to the new character string; and registers the third vector in a vector table included in the language model.

The present disclosure described herein provides an information processing method including generating a third vector using similarities between a first vector and respective second vectors, the first vector representing a new character string added to a language model, the second vectors each representing a respective one of a plurality of words to which the new character string is divided, the third vector corresponding to the new character string; and registering the third vector in a vector table included in the language model.

The present disclosure described herein provides a non-transitory recording medium storing a plurality of instructions which, when executed by one or more processors, causes the one or more processors to perform an information processing method including generating a third vector using similarities between a first vector and respective second vectors, the first vector representing a new character string added to a language model, the second vectors each representing a respective one of a plurality of words to which the new character string is divided, the third vector corresponding to the new character string; and registering the third vector in a vector table included in the language model.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a system configuration of a character string dividing system;

FIG. 2 is a diagram illustrating an example of a hardware configuration of a server and a personal computer (PC);

FIG. 3 is a block diagram illustrating an example of functions of the server;

FIG. 4 is a flowchart illustrating an example of a procedure of an addition process performed by the server;

FIG. 5 is a diagram illustrating an example of input data and output data of the addition process performed by the server;

FIG. 6 is a diagram illustrating an example of an internal configuration of a language model illustrated in FIG. 5;

FIG. 7 is a diagram illustrating an example of an internal configuration of a model illustrated in FIG. 5;

FIG. 8 is a diagram illustrating an example of how a similarity calculation unit included in the server calculates a similarity;

FIG. 9 is a diagram illustrating an example of how a registration unit included in the server registers a vector;

FIG. 10 is a block diagram illustrating an example of functions of the server;

FIG. 11 is a flowchart illustrating an example of a procedure of a generative artificial intelligence (AI) chat process performed by the server;

FIG. 12 is a diagram illustrating an example of a generative AI chat screen displayed on a user terminal under the control of the server; and

FIG. 13 is a diagram illustrating an example of the generative AI chat screen displayed on the user terminal under the control of the server.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### Example of System Configuration of Character String Dividing System 10

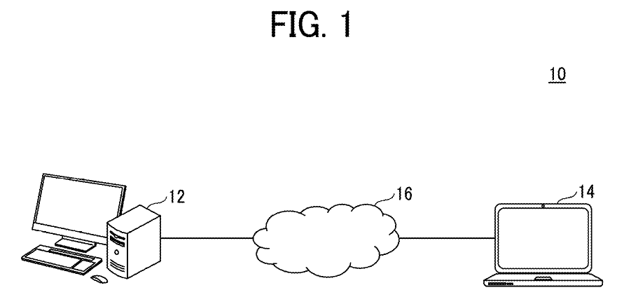

FIG. 1 is a diagram illustrating an example of a system configuration of a character string dividing system 10.

The character string dividing system 10 illustrated in FIG. 1 is an example of an “information processing system”. The character string dividing system 10 includes a server 12 and a PC 14. The server 12 and the PC 14 are communicably connected to each other via a communication network 16. Examples of the communication network 16 to be used include a local area network (LAN) and the Internet.

The PC 14 is an example of a “terminal apparatus”. The PC 14 includes an input device for inputting a character string. Examples of the input device include a keyboard and a touch panel. The PC 14 transmits a character string input by a user with the input device to the server 12 via the communication network 16. The PC 14 may have a speech recognition function for recognizing speech input by a user with a microphone. In this case, the PC 14 may transmit a character string of the speech recognized by the speech recognition function to the server 12.

The server 12 is an example of an “information processing apparatus”. The server 12 receives the character string transmitted from the PC 14 via the communication network 16. The server 12 performs predetermined processes (e.g., a character string division process and a prediction process) to generate text corresponding to the received character string.

The server 12 outputs the text, which is obtained as a processing result of processing performed by an LLM, to the PC 14 via the communication network 16.

For example, the server 12 includes an LLM. The LLM is a machine learning model and performs prediction (inference) from an input character string and outputs output text. The LLM includes a tokenizer and an embedding layer. The tokenizer has a word group (dictionary). The word group includes multiple words associated with token IDs (identifiers). The word group is implemented by a JavaScript Object Notation (JSON) file, for example. Based on the word group, the tokenizer performs a character string division process (i.e., tokenization process) using a technique of the related art on the character string acquired from the PC 14 to divide the character string acquired from the PC 14 into multiple words (i.e., multiple morphemes) and output token IDs corresponding to the respective divided words. The embedding layer includes a vector table. The vector table includes associations between a token ID and a vector. The vector is a high-dimensional vector, ranging from hundreds to tens of thousands of dimensions. Based on the vector table, the embedding layer identifies vectors corresponding to the token IDs acquired by the tokenizer and outputs the identified vectors. The LLM performs the prediction process on the vectors corresponding to the multiple words obtained by the tokenizer to predict text corresponding to the input character string. The server 12 outputs the text predicted by the LLM to the PC 14 via the communication network 16. As described above, in the present disclosure, examples of the word, which is the outcome of the character string division process, is not limited to a word having specific meaning, but any part of the work such as a sub-word that may be divided through the tokenization process.

The PC 14 receives the text transmitted from the server 12 (i.e., the text obtained as the processing result by the LLM) via the communication network 16, and performs various processes (e.g., displaying a screen) using the text.

In the example illustrated in FIG. 1, a single terminal apparatus (i.e., the PC 14) is connected to the server 12 via the communication network 16. In the actual character string dividing system 10, multiple terminal apparatuses are connectable to the server 12 via the communication network 16 and each of the multiple terminal apparatuses can transmit a character string to the server 12.

In the example illustrated in FIG. 1, the PC 14 is used as an example of a terminal apparatus to which a character string is input. However, the terminal apparatus is not limited to this example and may be any other apparatuses that can at least receive input of a character string and transmit the character string, for example, a smartphone, a tablet terminal, an electronic whiteboard, an ink jet printer, a multifunctional peripheral (MFP), a videoconference terminal, a projector, and a spherical image capturing device.

### Hardware Configuration of Server 12 and PC 14

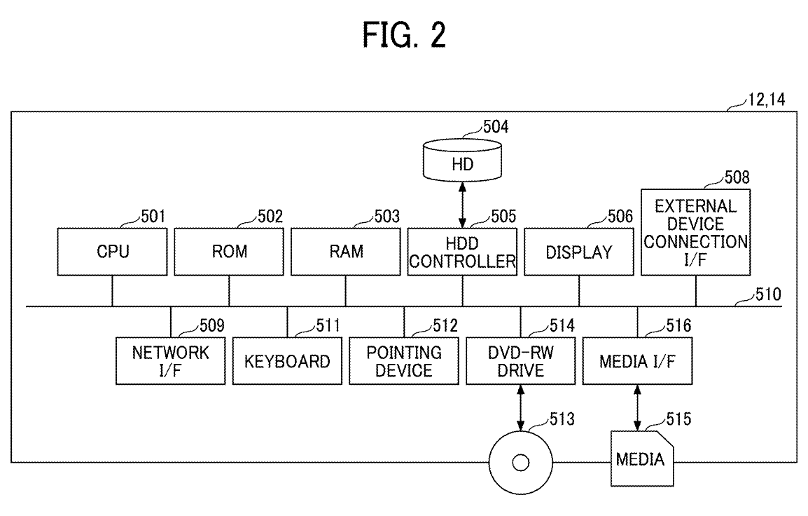

FIG. 2 is a diagram illustrating an example of a hardware configuration of the server 12 and the PC 14. The hardware configuration that is common to the server 12 and the PC 14 will be described.

The server 12 and the PC 14 are each implemented by a computer. As illustrated in FIG. 2, the server 12 and the PC 14 each include, for example, a central processing unit (CPU) 501, a read-only memory (ROM) 502, a random access memory (RAM) 503, a hard disk (HD) 504, a hard disk drive (HDD) controller 505, a display 506, an external device connection interface (I/F) 508, a network I/F 509, a data bus 510, a keyboard 511, a pointing device 512, a digital versatile disk rewritable (DVD-RW) drive 514, and a media I/F 516.

The CPU 501 controls the overall operation of the server 12 or the PC 14. The ROM 502 stores programs, such as an initial program loader (IPL), for driving the CPU 501. The RAM 503 is used as a work area for the CPU 501. The HD 504 stores various kinds of data such as a program. The HDD controller 505 controls reading or writing of various kinds of data from or to the HD 504 under the control of the CPU 501. The display 506 displays various kinds of information such as a cursor, a menu, a window, text, or an image. The external device connection I/F 508 is an interface that connects various external devices to the server 12 or the PC 14. Examples of the external devices include a Universal Serial Bus (USB) memory and a printer. The network I/F 509 is an interface that enables communication of data via the communication network 16. The data bus 510 is, for example, an address bus or a data bus that electrically connects the components such as the CPU 501 illustrated in FIG. 2 to one another.

The keyboard 511 is an example of an input device provided with multiple keys to receive input of characters, numerical values, various instructions, and the like. The pointing device 512 is an example of an input device to receive selection or execution of a specific instruction, selection of a target for processing, or movement of a cursor. The DVD-RW drive 514 controls reading or writing of various kinds of data from and to a DVD-RW 513, which is an example of a removable recording medium. The removable recording medium is not limited to the DVD-RW 513 and may be a digital versatile disk recordable (DVD-R) or the like. The media I/F 516 controls reading or writing (storing) of data from or to a recording medium 515 such as a flash memory.

### Functional Configuration of Server 12

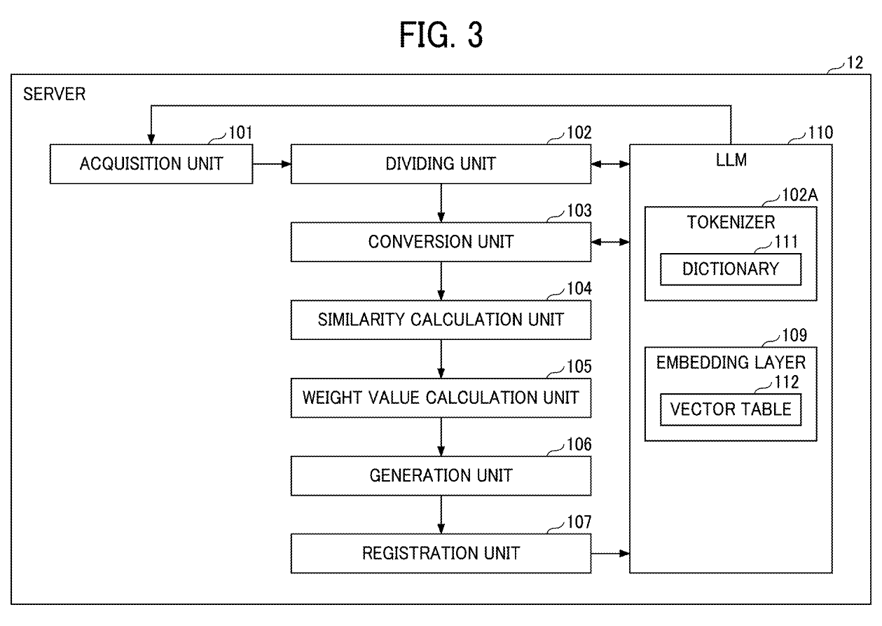

FIG. 3 is a block diagram illustrating an example of functions of the server 12. FIG. 3 illustrates multiple functions related to addition of a vector corresponding to a new character string among multiple functions of the server 12.

As illustrated in FIG. 3, the server 12 includes an acquisition unit 101, a dividing unit 102, a conversion unit 103, a similarity calculation unit 104, a weight value calculation unit 105, a generation unit 106, and a registration unit 107. The server 12 includes an LLM 110.

The LLM 110 is an example of a “language model”. The LLM 110 includes a tokenizer 102A, an embedding layer 109, a dictionary 111, and a vector table 112. The dictionary 111 stores a character string, words, and token IDs (identifiers) associated with the character string and the words. The vector table 112 stores a vector for each of the token IDs (identifiers) corresponding to the character string and the words registered in the dictionary 111. The tokenizer 102A may include the dictionary 111, and the embedding layer 109 may include the vector table 112.

The acquisition unit 101 acquires a new character string added to the dictionary 111 of the LLM 110.

The dividing unit 102 divides the new character string acquired by the acquisition unit 101 into multiple words. The dividing unit 102 uses, as the multiple words, words already registered in the dictionary 111 of the LLM 110. Specifically, the dividing unit 102 uses the dictionary 111 to divide the new character string into multiple words by the tokenization function of the tokenizer 102A. For example, when the new character string acquired by the acquisition unit 101 is “I am”, the dividing unit 102 divides the new character string “I am” into a word “I” and a word “am” that are already registered in the dictionary 111 of the LLM 110.

The conversion unit 103 converts the new character string acquired by the acquisition unit 101 into a first vector. The conversion unit 103 converts the multiple words obtained by the dividing unit 102 into respective second vectors. For example, the conversion unit 103 uses a publicly available embedding model to convert the new character string into the first vector and convert the multiple words into the respective second vectors. For example, the conversion unit 103 converts the new character string “I am” into the first vector and converts the word “I” and the word “am” into the second vectors. The conversion unit 103 converts, with the embedding layer 109 of the LLM 110, the multiple words obtained by the dividing unit 102 into respective fourth vectors.

The similarity calculation unit 104 uses a publicly available technique for calculating a similarity between vectors to calculate a similarity between each of the second vectors obtained by the conversion unit 103 and the first vector obtained by the conversion unit 103. For example, the similarity calculation unit 104 calculates a cosine similarity as the similarity. The similarity is not limited to the cosine similarity. For example, the similarity calculation unit 104 may calculate, as the similarity, the Euclidean distance or the “maximum inner product” determined based on an inner product of two vectors. For example, the similarity calculation unit 104 calculates a similarity between the first vector corresponding to the new character string “I am” and the second vector corresponding to the word “I” and a similarity between the first vector corresponding to the new character string “I am” and the second vector corresponding to the word “am”. When the cosine similarity is used, a value ranging from −1 to +1 is calculated.

The weight value calculation unit 105 performs a normalization process on the similarities calculated by the similarity calculation unit 104 for the multiple second vectors to calculate weight values for the respective fourth vectors. The weight value calculation unit 105 calculates the weight values for the respective fourth vectors so that the sum of the weight values is equal to 1. For example, the weight value calculation unit 105 performs processing to make the sum of the weight values equal to 1. For example, the weight value calculation unit 105 calculates “0.9” through the normalization process from the similarity between the first vector for “I am” and the second vector for “I” and “0.1” through the normalization process from the similarity between the first vector for “I am” and the second vector for “am”. In this case, the weight value for the fourth vector for the word “I” is “0.9” and the weight value for the fourth vector for the word “am” is “0.1”. A larger weight value indicates a higher similarity to the first vector. The weight for the fourth vector to which a word is vectorized by a language model is a weight calculated from the similarity (i.e., the similarity between the first vector and the second vector) calculated using the second vector to which the word is vectorized by the embedding model.

The generation unit 106 generates a third vector corresponding to the new character string acquired by the acquisition unit 101 from the multiple fourth vectors obtained by the conversion unit 103 and the weight values calculated by the weight value calculation unit 105 for the respective fourth vectors. Specifically, the generation unit 106 adds up products of the multiple fourth vectors and the respective weight values to generate the third vector. The normalization process performed by the weight value calculation unit 105 may be omitted. In this case, the generation unit 106 may obtain a weighted average of the multiple fourth vectors based on the respective weight values to generate the third vector corresponding to the new character string. For example, the generation unit 106 adds up the product of the fourth vector for the word “I” and the weight value “0.9” and the product of the fourth vector for the word “am” and the weight value “0.1” to generate the third vector corresponding to the new character string “I am”.

The registration unit 107 registers the third vector generated by the generation unit 106 in the vector table 112 of the LLM 110. The registration unit 107 registers the third vector and the token ID in the vector table 112 in association with each other. The registration unit 107 may assign a new token ID to the third vector, or may assign a token ID that has been assigned to a dispensable word to the third vector. In the latter case, a dispensable word that has a low influence on the accuracy can be deleted and the increase in size of the vector table 112 can be suppressed. The token ID associated with the third vector is the same as the token ID corresponding to the new character string in the dictionary 111. For example, when the token ID corresponding to the new character string in the dictionary 111 is a new token ID, the token ID associated with the third vector in the vector table 112 is the new token ID. For example, when the token ID corresponding to the new character string in the dictionary 111 is the existing token ID that has been associated with a dispensable word, the token ID associated with the third vector in the vector table 112 is the existing token ID that has been associated with the dispensable word.

The token ID associated with the new character string in the dictionary 111 is corrected to the token ID assigned to the third vector by the registration unit 107 to make the token ID associated with the third vector the same as the token ID corresponding to the new character string in the dictionary 111.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

At least one (e.g., the tokenizer 102A or the embedding model) of the functions illustrated in FIG. 3 may be included in another apparatus (e.g., another server communicably connectable to the server 12 or another server on the Internet) in the character string dividing system 10.

### Example of Procedure of Addition Process by Server 12

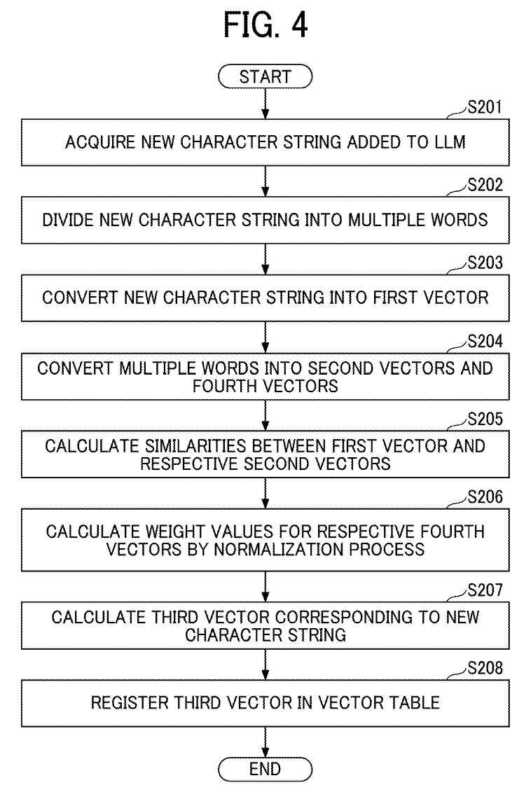

FIG. 4 is a flowchart illustrating an example of a procedure of an addition process performed by the server 12.

In step S201, the acquisition unit 101 acquires a new character string added to the dictionary 111 of the LLM 110.

In step S202, the dividing unit 102 divides the new character string acquired in step S201 into multiple words.

In step S203, the conversion unit 103 uses the embedding model to convert the new character string acquired in step S201 into a first vector. In step S204, the conversion unit 103 uses the embedding model to convert the multiple words obtained in step S202 into respective second vectors. In step S204, the conversion unit 103 uses the embedding layer 109 of the LLM 110 to convert the multiple words obtained in step S202 into respective fourth vectors.

In step S205, the similarity calculation unit 104 calculates similarities between the first vector obtained in step S203 and the respective second vectors obtained in step S204.

In step S206, the weight value calculation unit 105 performs the normalization process on the similarities between the first vector and the respective second vectors calculated in step S205 to calculate weight values for the respective fourth vectors.

In step S207, the generation unit 106 generates a third vector corresponding to the new character string obtained in step S201 from the multiple fourth vectors acquired in step S204 and the weight values calculated for the respective fourth vectors in step S206.

In step S208, the registration unit 107 registers the third vector generated in step S207 in the vector table 112 of the LLM 110. The server 12 then ends the process illustrated in FIG. 4.

When multiple new character strings are added to the dictionary 111 of the LLM 110, the server 12 performs the process illustrated in FIG. 4 on each of the multiple new character strings. That is, the server 12 repeatedly performs the process illustrated in FIG. 4 for each new character string. Thus, the server 12 can generate and register the third vector for each of the multiple new character strings added to the dictionary 111 of the LLM 110. A character string is added to a language model, for example, in the case where the accuracy of language processing increases when a character string “I am”, which is a combination of words “I” and “am”, is input to the language model as a new character string rather than when the words “I” and “am” are added individually and in the case where a tokenizer dedicated to English is used to tokenize “language processing” but a word “processing” of “language processing” is not registered and thus is to be newly registered.

### Example of Input Data and Output Data Used in Addition Process by Server 12

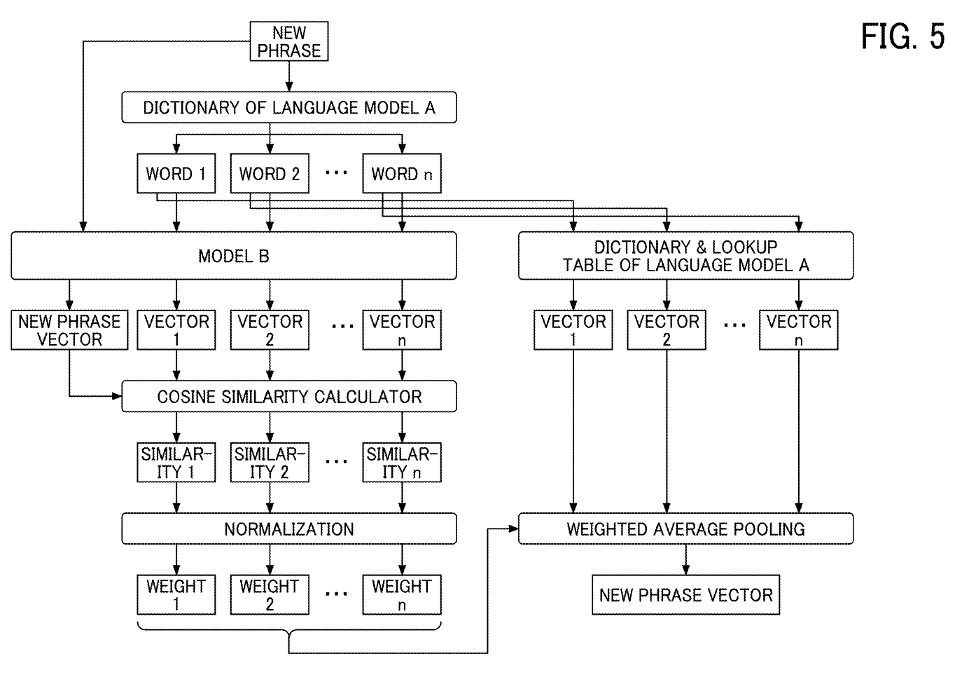

FIG. 5 is a diagram illustrating an example of input data and output data used in an addition process performed by the server 12. A “dictionary” in FIG. 5 corresponds to the dictionary 111. A “lookup table” in FIG. 5 corresponds to the vector table 112. A “new phrase” in FIG. 5 corresponds to the new character string added to the dictionary 111 of the LLM 110. A “cosine similarity calculator” in FIG. 5 corresponds to the similarity calculation unit 104.

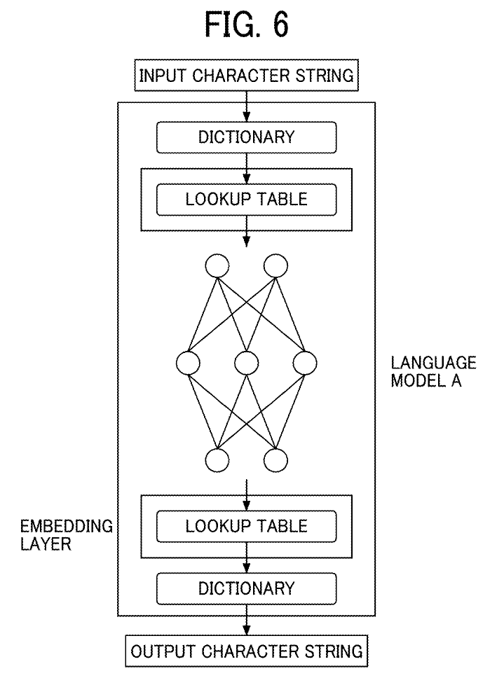

A “language model A” in FIG. 5 corresponds to the LLM 110. FIG. 6 illustrates an internal configuration of the “language model A”. A “model B” is a conversion model for converting an input character string into a vector. For example, a publicly available embedding model is used as the “model B”.

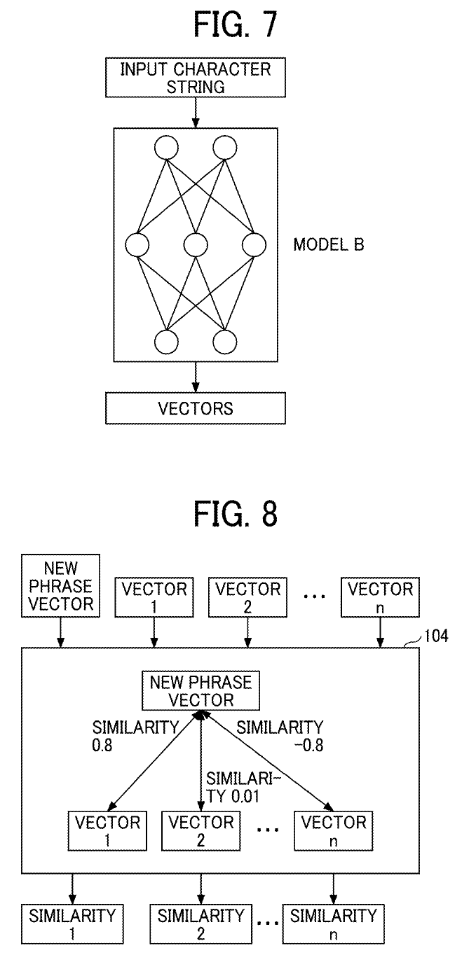

FIG. 7 illustrates an internal configuration of the “model B”.

As illustrated in FIG. 5, in the addition process performed by the server 12, a new phrase added to the dictionary of the language model A is input.

The dividing unit 102 uses the dictionary of the language model A to divide the input new phrase into multiple (n) words (i.e., a word 1, a word 2, ..., a word n).

The conversion unit 103 uses the model B to convert the input new phrase into a first vector (i.e., a new phrase vector). The conversion unit 103 uses the model B to convert the multiple words (i.e., the word 1, the word 2, ..., the word n) into second vectors (i.e., a vector 1, a vector 2, ..., a vector n).

The conversion unit 103 uses the dictionary and the lookup table of the language model A to convert the multiple words (i.e., the word 1, the word 2, ..., the word n) into fourth vectors (i.e., a vector 1, a vector 2, ..., a vector n).

The cosine similarity calculator calculates similarities (i.e., a similarity 1, a similarity 2, ..., a similarity n) between the first vector (i.e., the new phrase vector) and the respective second vectors (i.e., the vector 1, the vector 2, ..., the vector n).

The weight value calculation unit 105 performs the normalization process using the multiple similarities (i.e., the similarity 1, the similarity 2, ..., the similarity n) to calculate weight values (i.e., a weight 1, a weight 2, ..., a weight n) for the respective fourth vectors (i.e., the vector 1, the vector 2, ..., the vector n).

The generation unit 106 adds up products of the multiple fourth vectors (i.e., the vector 1, the vector 2, ..., the vector n) and the respective weight values (i.e., the weight 1, the weight 2, ..., the weight n) through weighted average pooling processing to generate a third vector (i.e., a new phrase vector) corresponding to the input new phrase.

### Example of Calculation of Similarity by Similarity Calculation Unit 104

FIG. 8 is a diagram illustrating an example of how the similarity calculation unit 104 included in the server 12 calculates a similarity.

As illustrated in FIG. 8, the similarity calculation unit 104 receives input of the first vector (i.e., the new phrase vector) of the new character string and the second vectors (i.e., the vectors 1 to n) of the multiple words.

As illustrated in FIG. 8, the similarity calculation unit 104 calculates the similarities between the input first vector (i.e., the new phrase vector) and the respective input second vectors (i.e., the vectors 1 to n).

As illustrated in FIG. 8, the similarity calculation unit 104 outputs the similarities (i.e., the similarities 1 to n) for the respective input second vectors (i.e., the vectors 1 to n).

### Example of Registration of Vector by Registration Unit 107

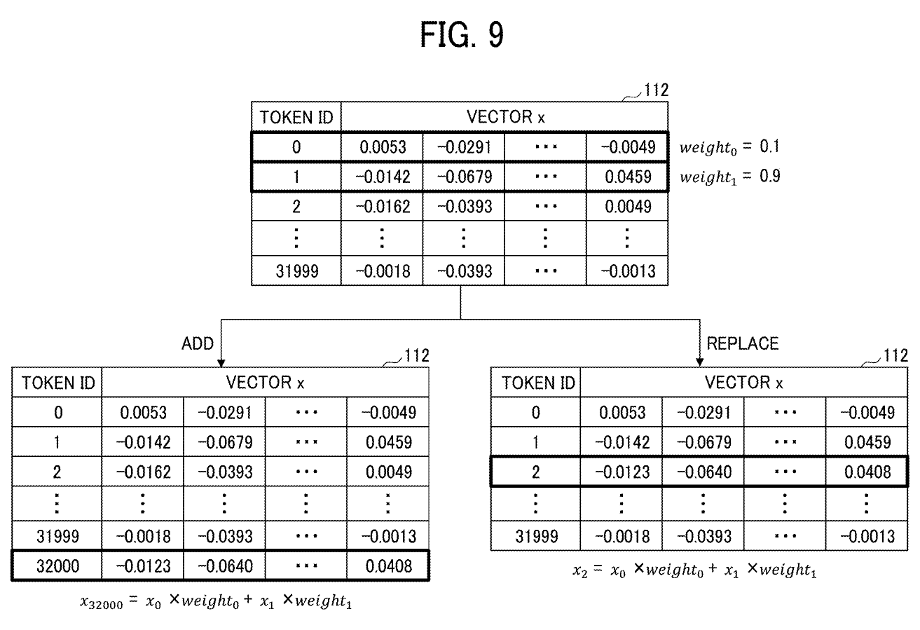

FIG. 9 is a diagram illustrating an example of how the registration unit 107 included in the server 12 registers a vector.

FIG. 9 illustrates an example in which the registration unit 107 registers the third vector generated by the generation unit 106 in the vector table 112 in association with the token ID.

In the example illustrated in FIG. 9, multiple (32000) vectors whose token IDs are from “0” to “31999” are registered in the vector table 112 before registration. That is, multiple vectors corresponding to multiple existing character strings and words are registered in the vector table 112 before registration.

FIG. 9 illustrates an example in which the registration unit 107 registers the vector corresponding to the new character string in the vector table 112 by addition. In this example, the registration unit 107 registers a vector X₃₂₀₀₀ corresponding to the new character string in the vector table 112 in association with a new token ID “32000” by addition.

FIG. 9 illustrates another example in which the registration unit 107 registers the vector corresponding to the new character string in the vector table 112 by replacement. In this example, the registration unit 107 registers a vector X₂ corresponding to the new character string in the vector table 112 in association with the existing token ID “2” by replacement. That is, in this example, the vector X₂ corresponding to the existing character string and associated with the token ID “2” is replaced with the vector X₂ corresponding to the new character string in the vector table 112 as a result of registration by replacement.

As described above, the registration unit 107 may register the vector corresponding to the new character string in the vector table 112 by addition or replacement. When the registration unit 107 registers the vector corresponding to the new character string in the vector table 112 by replacement, a dispensable word that has a low influence on the accuracy can be deleted and the increase in size of the vector table 112 can be suppressed.

An administrator or the like is allowed to select whether to register the vector corresponding to the new character string by addition or replacement.

As described above, the server 12 includes the dividing unit 102, the conversion unit 103, the similarity calculation unit 104, the generation unit 106, and the registration unit 107. The dividing unit 102 divides a new character string added to the LLM 110 into multiple words. The conversion unit 103 converts the new character string into a first vector and converts the multiple words into respective second vectors and respective fourth vectors. The similarity calculation unit 104 calculates similarities between the first vector and the respective second vectors. The generation unit 106 generates a third vector corresponding to the new character string from the multiple fourth vectors and the similarities for the multiple second vectors. The registration unit 107 registers the third vector in a vector table of the LLM 110.

In this manner, the server 12 can divide the new character string into the multiple words, and generate the third vector corresponding to the new character string from the multiple fourth vectors corresponding to the respective words and the similarities between the first vector and the respective second vectors without performing contrastive learning.

Thus, when a new character string is added to the LLM 110, the server 12 can register a vector corresponding to the character string in the LLM 110 without performing contrastive learning. Since the server 12 does not perform contrastive learning, the server 12 can register the vector corresponding to the character string in the LLM 110 at low calculation cost.

As described above, the server 12 can easily register a new character string and a vector corresponding to the new character string in the LLM 110 at low calculation cost when a model is fine-tuned to a specific task or a model is fine-tuned specifically to a specific industry.

An example of implementing a generative AI chat using an LLM having the vector table described in the above embodiment (i.e., the vector table generated by the server 12) will be described below.

### Functional Configuration of Server 12

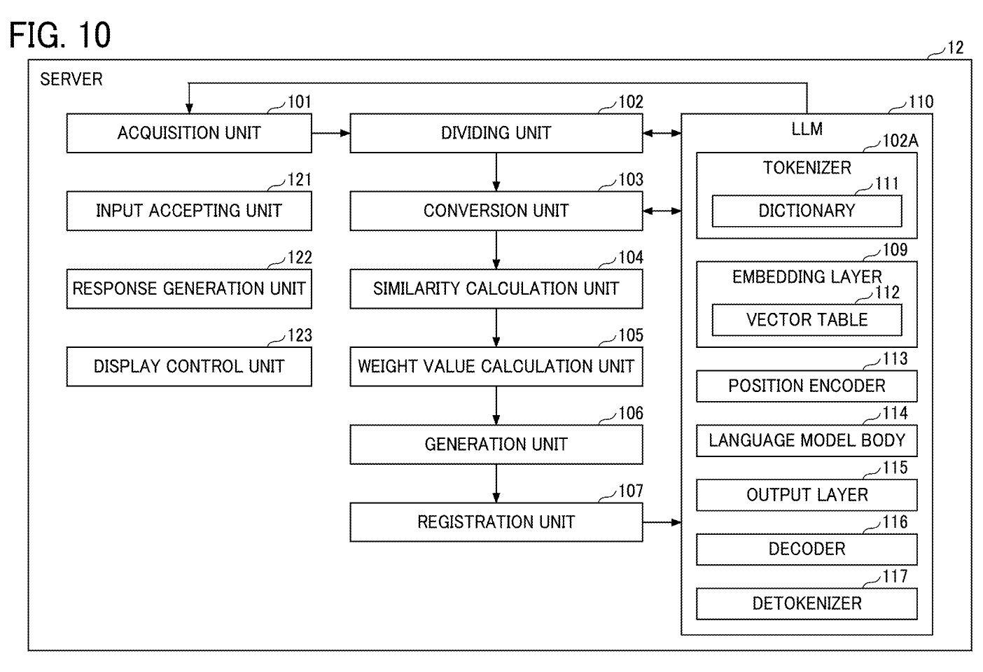

FIG. 10 is a block diagram illustrating an example of functions of the server 12. The functional configuration of the server 12 illustrated in FIG. 10 differs from the functional configuration of the server 12 illustrated in FIG. 3 in that multiple functions related to a generative AI chat process are added.

Specifically, the server 12 illustrated in FIG. 10 further includes an input accepting unit 121, a response generation unit 122, and a display control unit 123.

The input accepting unit 121 accepts input of input text, which is a natural sentence, from a user terminal.

The response generation unit 122 acquires a processing result obtained by the LLM 110 by processing the input text accepted by the input accepting unit 121, and generates response text from the processing result.

The display control unit 123 controls display of a screen on the user terminal. For example, the display control unit 123 transmits information on a generative AI chat screen to the user terminal to cause the user terminal to display the generative AI chat screen. For example, the display control unit 123 transmits the response text generated by the response generation unit 122 to the user terminal to cause the response text to be displayed in the generative AI chat screen displayed on the user terminal.

The LLM 110 of the server 12 illustrated in FIG. 10 further includes a position encoder 113, a language model body 114, an output layer 115, a decoder 116, and a detokenizer 117. The user terminal includes a communication unit and a display unit.

### Example of Procedure of Generative AI Chat Process by Server 12

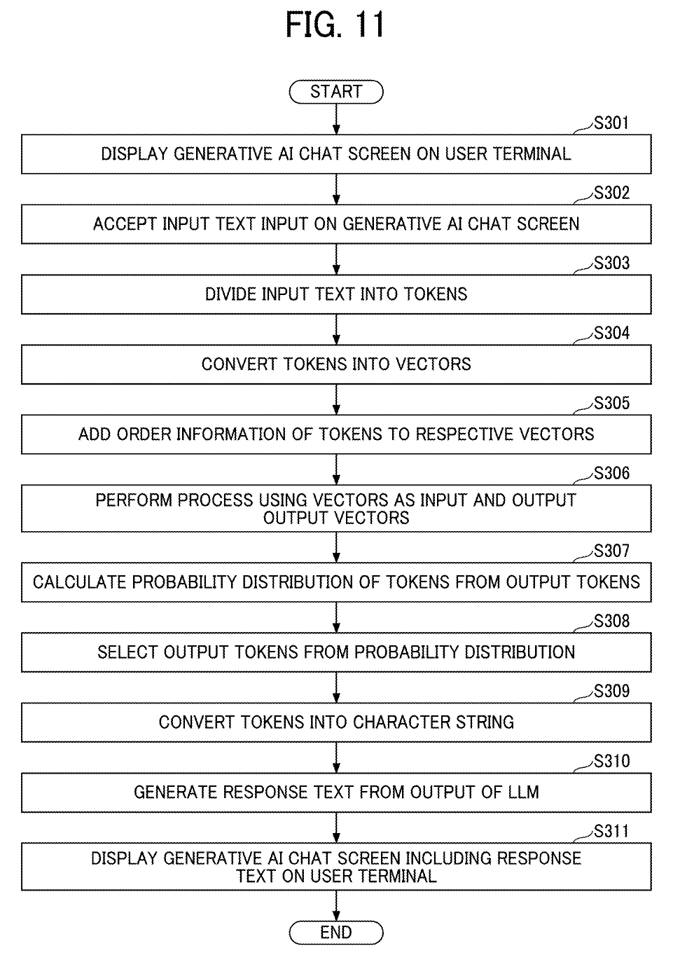

FIG. 11 is a flowchart illustrating an example of a procedure of the generative AI chat process performed by the server 12.

In step S301, the display control unit 123 transmits the information on the generative AI chat screen to the user terminal to cause the user terminal to display the generative AI chat screen. The communication unit of the user terminal receives the information on the generative AI chat screen transmitted from the server 12.

The display unit of the user terminal displays the generative AI chat screen based on the information on the generative AI chat screen.

In step S302, the communication unit of the user terminal transmits, to the server 12, input text input by the user on the generative AI chat screen. The input accepting unit 121 of the server 12 receives, from the user terminal, the input text which is a natural sentence input on the generative AI chat screen on the user terminal to accept input of the input text.

In step S303, the tokenizer 102A of the LLM 110 divides the input text accepted in step S302 into tokens.

In step S304, the embedding layer 109 of the LLM 110 uses the vector table 112 to convert the tokens obtained in step S303 into vectors.

In step S305, the position encoder 113 of the LLM 110 adds order information of the tokens to the respective vectors obtained in step S304.

In step S306, the language model body 114 of the LLM 110 performs a process in which the vectors to which the order information is added in step S305 are the input, and outputs output vectors as a result of the process.

In step S307, the output layer 115 calculates a probability distribution of tokens from the output vectors output in step S306, and outputs the probability distribution.

In step S308, the decoder 116 selects output tokens from the probability distribution output in step S307.

In step S309, the detokenizer 117 converts the tokens selected in step S308 into a character string. The detokenizer 117 has a dictionary in which token IDs are associated with respective character strings. The detokenizer 117 uses the dictionary to convert the tokens into a character string. The dictionary is common to the dictionary of the tokenizer 102A. The character string generated in step S309 is the output of the LLM 110.

In step S310, the response generation unit 122 generates response text from the character string output from the LLM 110 in step S309. The response generation unit 122 may use, as the response text, the character string output from the LLM 110 or may generate the response text based on the character string output from the LLM 110.

In step S311, the display control unit 123 transmits information on the generative AI chat screen including the response text generated in step S310 to the user terminal to cause the user terminal to display the generative AI chat screen including the response text. The communication unit of the user terminal receives the information on the generative AI chat screen transmitted from the server 12. The display unit of the user terminal displays the generative AI chat screen based on the information on the generative AI chat screen. The server 12 then ends the process illustrated in FIG. 11.

### Example of Generative AI Chat Screen

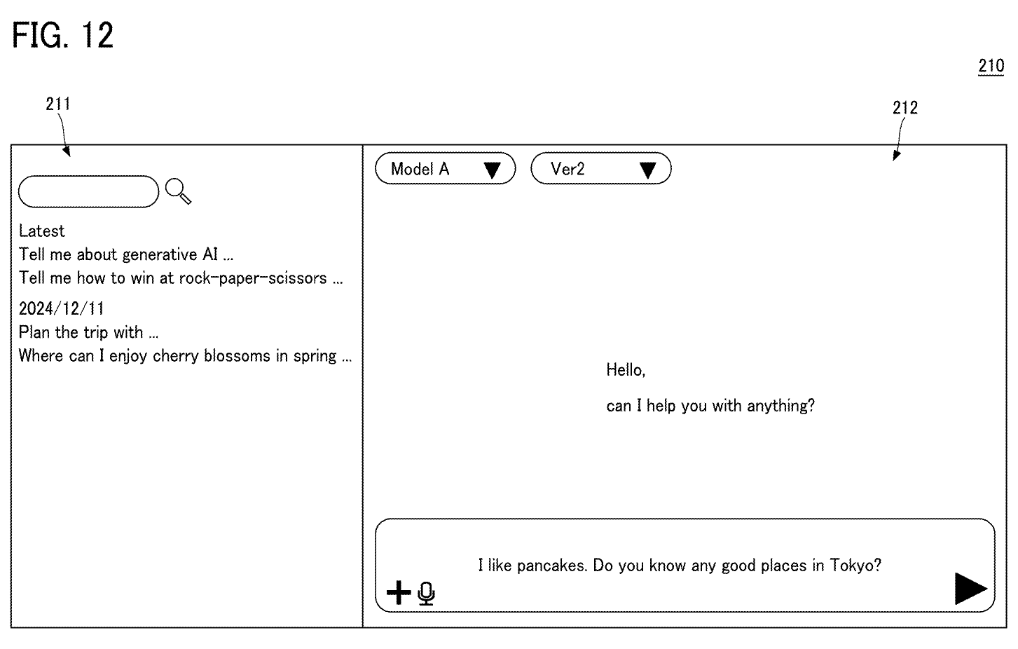

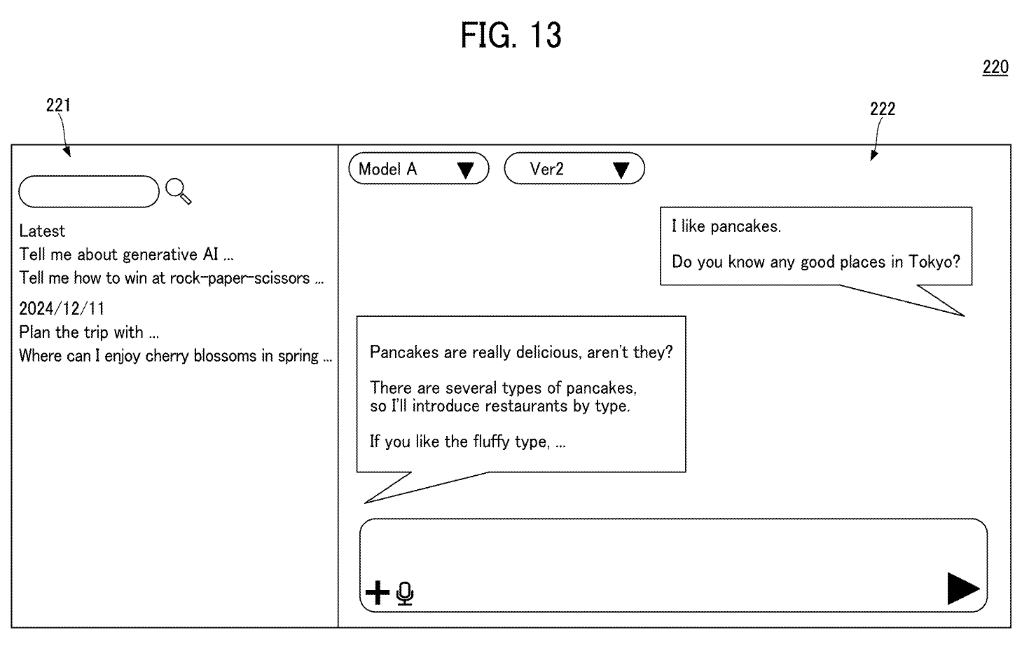

FIGS. 12 and 13 are diagrams illustrating an example of the generative AI chat screen displayed on the user terminal under the control of the server 12.

A generative AI chat screen 210 illustrated in FIG. 12, which is displayed on the user terminal under the control of the display control unit 123, displays the input text input by the user. In the example illustrated in FIG. 12, an input field at the bottom of a display area 212 on the right side in the generative AI chat screen 210 displays “I like pancakes. Do you know any good places in Tokyo?” as the input text which is a natural sentence input by the user. The user can send the input text to the server 12 by pressing a triangular send button displayed in the input field. The input field further displays a button for audio input and a button for attaching a file. The user can input the input text by voice and attach a file as the input text by pressing these buttons.

A generative AI chat screen 220 illustrated in FIG. 13 displays the response text to the input text under the control of the display control unit 123. In the example illustrated in FIG. 13, a display area 222 on the right side in the generative AI chat screen 220 displays the input text input by the user and the response text generated by the response generation unit 122 for the input text in chronological order.

Display areas 211 and 221 on the left side respectively in the generative AI chat screens 210 and 220 each display a generative AI chat history. The generative AI chat history may be sorted into and displayed as groups such as “Latest” and “12/11/2024 (date)”.

The display areas 211 and 221 display a search field. When the user inputs a search word in this search field, the generative AI chat history matching the search word can be displayed.

Upper portions of the display areas 212 and 222 on the right side respectively in the generative AI chat screens 210 and 220 each display a field for selecting the model and a field for selecting the version of the vector table 112. The field for selecting the model allows the user to select the language model of the LLM 110. The field for selecting the version of the vector table 112 allows the user to select the version (i.e., pre-update version or post-update version described above) of the vector table 112. The field for selecting the version of the vector table 112 may be omitted.

In the related art, when a new character string is added to a language model, contrastive learning is performed to generate a word embedding vector. Thus, registering a vector corresponding to the character string in the language model involves large calculation cost.

The information processing apparatus according to an embodiment facilitates registration of the vector corresponding to the new character string in the language model when the new character string is added to the language model.

The apparatuses or devices described in the embodiments are just one example of multiple computing environments that implement the embodiments disclosed herein. In some embodiments, the server 12 includes multiple computing devices, such as a server cluster. The multiple computing devices communicate with one another through any type of communication link including a network, a shared memory, or the like and perform the processes disclosed herein.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing system comprising circuitry configured to:
generate a third vector using similarities between a first vector and respective second vectors,
the first vector representing a new character string added to a language model,
the second vectors each representing a respective one of a plurality of words to which the new character string is divided, the third vector corresponding to the new character string; and
register the third vector in a vector table included in the language model.

2. The information processing system according to claim 1, wherein the circuitry is configured to:
divide the new character string added to the language model into the plurality of words;
convert the new character string into the first vector and convert the plurality of words into the respective second vectors; and
calculate the similarities between the first vector and the respective second vectors.

3. The information processing system according to claim 2, wherein the circuitry is configured to:
convert the new character string into the first vector and the plurality of words into the respective second vectors using a model different from the language model;
convert the plurality of words into respective fourth vectors using the language model; and
generate the third vector using the fourth vectors and the similarities.

4. The information processing system according to claim 3, wherein the circuitry is configured to:
perform a normalization process on the similarities between the first vector and the respective second vectors to calculate weight values for the respective fourth vectors; and
generate the third vector corresponding to the new character string from the fourth vectors and the respective weight values.

5. The information processing system according to claim 4, wherein the circuitry is configured to:
receive input text from a user terminal;
generate response text to the input text using the language model in which the third vector is registered; and
transmit information on a screen including the response text to the user terminal.

6. The information processing system according to claim 1, further comprising:
an information processing apparatus including the circuitry.

7. The information processing system according to claim 5, further comprising:
an information processing apparatus including the circuitry; and
the user terminal including terminal circuitry configured to:
transmit the input text input by a user to the information processing apparatus;
receive the information on the screen including the response text from the information processing apparatus; and
display the screen including the response text based on the information on the screen including the response text.

8. An information processing method comprising:
generating a third vector using similarities between a first vector and respective second vectors,
the first vector representing a new character string added to a language model,
the second vectors each representing a respective one of a plurality of words to which the new character string is divided, the third vector corresponding to the new character string; and
registering the third vector in a vector table included in the language model.

9. A non-transitory recording medium storing a plurality of instructions which, when executed by one or more processors, causes the one or more processors to perform an information processing method comprising:
generating a third vector using similarities between a first vector and respective second vectors,
the first vector representing a new character string added to a language model,
the second vectors each representing a respective one of a plurality of words to which the new character string is divided, the third vector corresponding to the new character string; and
registering the third vector in a vector table included in the language model.
